(19) United States
(12) Patent Application Publication
(10) Pub. No.: US 2010/0139157 A1
(43) Pub. Date: Jun. 10, 2010

(54) FUNGAL BED CULTIVATION METHOD OF HON-SHIMEJI MUSHROOM

(75) Inventors: Takashi Kawai, Otsu-shi (JP); Mayu Hashimoto, Otsu-shi (JP); Takeshi Sugimori, Otsu-shi (JP); Katsuhiko Kusakabe, Otsu-shi (JP); Akihiko Kita, Ostu-shi (JP); Ikunoshin Kato, Otsu-shi (JP)

Correspondence Address: BROWDY AND NEIMARK, P.L.L.C.;624 NINTH STREET, NW, SUITE 300, WASHINGTON, DC, 20001-5303, US

(73) Assignee: TAKARA BIO INC., Otsu-shi (JP)

(21) Appl. No.: 12/627,341

(22) Filed: Nov. 30, 2009

(30) Foreign Application Priority Data
Nov. 28, 2008 (JP) 2008-304138

(51) Int. Cl. A01G 1/04

(52) U.S. Cl. 47/1.1

(57) ABSTRACT

A fungal bed cultivation method of a hon-shimeji mushroom, in which the sprouting step and/or fruit body growing step is carried out under an environmental condition of high CO₂ concentration, is provided. Examples of the environmental condition of high CO₂ concentration include a CO₂ concentration of 2,500 ppm or more in the sprouting step and a CO₂ concentration of 5,000 ppm or more in the fruit body growing step. Since the formation ratio of a budlet in the fungal bed cultivation of a hon-shimeji mushroom is improved by embodiments of the present invention, stable production of a hon-shimeji mushroom by its large scale commercial cultivation becomes possible.

### FOREIGN PRIORITY

This application is based on Japanese Patent Application No. 2008-304138, filed on Nov. 28, 2008, the entire contents thereof being hereby incorporated by reference.

### FIELD OF THE INVENTION

The present invention relates to a fungal bed cultivation method of hon-shimeji mushroom (Lyophyllum shimeji).

### BACKGROUND

A hon-shimeji mushroom is a mushroom which is generated on the ground of a forest of white oak or a mixed forest of white oak and Japanese red pine about in the middle of October. The hon-shimeji mushroom is regarded as a mushroom of the highest quality among edible mushrooms in Japan. Specifically, along with the matsutake mushroom (Tricholoma matsutake), it is said “a matsutake mushroom for flavor, a shimeji mushroom for taste”. In recent years, a fungal bed cultivation method for artificially cultivating edible mushrooms, such as an enokitake mushroom (Flammulina velutipes), a hiratake mushroom (Pleurotus ostreatus), a nameko mushroom (Pholiota nameko), a buna-shimeji mushroom (Hypsizygus marmoreus), a maitake mushroom (Grifola frondosa) and the like, using a culture medium prepared by mixing sawdust with nutrient sources, such as rice bran, wheat bran and the like, has been conceived. Thus, the mushrooms can be harvested stably throughout the year regardless of the season. Since a hon-shimeji mushroom is also an exceedingly delicious mushroom, it is desired to establish its own artificial cultivation method. However, hon-shimeji mushrooms are a mycorrhizal fungus, while the aforementioned enokitake mushroom and the like are wood-rotting fungi. Thus, it is considered that an artificial fungal bed cultivation method for hon-shimeji mushrooms is difficult to achieve.

However, Dr. Ohta of Forest Research Center of Shiga Prefecture has succeeded for the first time in carrying out the artificial fungal bed cultivation of a hon-shimeji mushroom. A fungal bed cultivation method of a hon-shimeji mushroom using wheat or the like is disclosed in Patent Document 1 (JP-A-07-115844), and a test for generating a hon-shimeji mushroom fruit body on a cultivation medium which uses wheat or the like is disclosed in Non-patent Document 1 (Journal of The Mycological Society of Japan, vol. 39, pp. 13-20, 1998).

In addition, Patent Document 2 (JP-A-06-153695) discloses a mycelium cultivation method of mycorrhizal fungi using a culture medium in which peat-moss is used as the base material and starch and the like is added thereto. The same inventors have reported in Non-patent Document 2 (Journal of The Mycological Society of Japan, vol. 35, pp. 192-195, 1994) on a test for generating a hon-shimeji mushroom fruit body by a culture medium in which peat-moss is used as the base material and starch and the like is added thereto.

However, the cost for the medium used in the method of Patent Document 1 (JP-A-07-115844) is high because the wheat or the like to be used in the medium is expensive. Additionally, the method of the inventors of Patent Document 2 (JP-A-06-153695) has not reached an industrial production level yet because the yield of the fruit bodies generated is low.

In recent years, various cultivation methods of a hon-shimeji mushroom have been disclosed with the aim toward industrial cultivation of a hon-shimeji mushroom. Patent Document 3 (JP-A-2000-106752) discloses a culture medium for cultivation on fungal bed of a hon-shimeji mushroom, which contains a Panicum subfamily plant, and a method for cultivating a hon-shimeji mushroom using said culture medium. In addition, Patent Document 4 (JP-A-2002-247917) discloses a fungal bed cultivation method of a hon-shimeji mushroom, in which its fruit bodies are generated by preparing a mixed medium containing at least corn powder and sawdust of a broad-leaved tree, inoculating the mycelia of a hon-shimeji mushroom on said mixed medium under a moisture-wet condition and culturing them at 30° C. or less.

Patent Document 5 (JP-A-2005-27585) discloses a fungal bed cultivation method of a hon-shimeji mushroom, in which crushed oyster shell is mixed with a medium which can generate fruit bodies when the mycelia of a hon-shimeji mushroom are inoculated and cultured under a moisture-wet condition. Further, the pH of the medium is adjusted to a range not exceeding 7.

Patent Document 6 (JP-A-2007-54044) discloses a fungal bed cultivation method of a hon-shimeji mushroom, in which a mixed medium is prepared by mixing small amounts of wheat or the like and/or rice or the like with a medium containing corn and sawdust. Fruit bodies are generated after inoculating and culturing a hon-shimeji mushroom on said mixed medium under a moisture-wet condition.

In Patent Document 1 (JP-A-07-115844), it is examined whether or not a primordia of a fruit body is formed, by culturing a strain of a hon-shimeji mushroom at 23° C. for 70 days and then lowering the temperature to 15° C. Further, the formation ratio of a fruit body is increased by covering the medium surface with peat. Additionally, in Non-patent Document 1 (Journal of The Mycological Society of Japan, vol. 39, pp. 13-20, 1998), fruit bodies are generated by adding peat onto the medium to a thickness of 1 cm when mycelia of the mushroom have extended throughout the culture medium during a culturing step at 22° C. The medium is cultured for 2 weeks thereafter and then transferred to a generation room set at 15° C. after completion of the culturing.

In Non-patent Document 2 (Journal of The Mycological Society of Japan, vol. 35, pp. 192-195, 1994), a strain of a hon-shimeji mushroom is inoculated on the culture medium and then cultured and aged at 23° C., and then a generation operation is carried out in a generation room set at 16° C. to observe formation of a primordia of a fruit body on between the 13th and 15th day thereafter.

In Patent Document 3 (JP-A-2000-106752), a bottle cultivation method comprising the respective steps of medium preparation, filling a bottle, sterilization, inoculation, culturing, sprouting, growth and harvest are disclosed, with a primordia of a fruit body being formed during the sprouting step after the culturing. Additionally in the examples, the sprouting step is carried out by covering with Akadama soil.

In Examples of Patent Document 4 (JP-A-2002-247917), a strain of a hon-shimeji mushroom is cultured at 23° C. for 60 days and further cultured by covering the top face of the medium with Kanuma soil for seven days. Further, the generation of a fruit body is then accelerated by transferring to a generation room of 15° C.

In Examples of Patent Document 5 (JP-A-2005-27585), a strain of a hon-shimeji mushroom is cultured at 23° C. for 70 days and then transferred to a generation room set at 15° C. Further, the cap is removed when a small fruit body is developed, and the fruit body is harvested when it has grown to a stage that its pileus has opened.

In Examples of Patent Document 6 (JP-A-2007-54044), a strain of a hon-shimeji mushroom is cultured at 23° C. for 55 days and is further cultured for ten days with the top face of the medium covered with Kanuma soil. The generation of a fruit body is then accelerated by transferring to a generation room set at 15° C.

[Patent Document 1] JP-A-07-115844

[Patent Document 2] JP-A-06-153695

[Patent Document 3] JP-A-2000-106752

[Patent Document 4] JP-A-2002-247917

[Patent Document 5] JP-A-2005-27585

[Patent Document 6] JP-A-2007-54044

[Non-patent Document 1] Journal of The Mycological Society of Japan, vol. 39, pp. 13-20, 1998

[Non-patent Document 2] Journal of The Mycological Society of Japan, vol. 35, pp. 192-195, 1994

### BRIEF SUMMARY

The present inventors have begun commercial cultivation of a hon-shimeji mushroom based on the techniques similar to those disclosed in the aforementioned Patent Document 3. However, since stabilization of production is necessary in carrying out large scale commercial cultivation, further development of these techniques is needed.

Thus, in view of the above-mentioned situation one of the objects of the present invention is to provide a fungal bed cultivation method allowing stable, large scale commercial cultivation of hon-shimeji mushrooms.

Generally, it has been considered necessary to keep excellent air permeability during a period from culturing of mycelium to formation of a fruit body in a fungal bed cultivation method of a hon-shimeji mushroom (Non-patent Document 1). The present inventors have carried out cultivation studies to examine the effects various factors have on the fungal bed cultivation of a hon-shimeji mushroom, and have intensively examined the influence of these factors on large scale commercial cultivation. As a result, it has surprisingly been found that the formation ratio of a sprout (a budlet) becomes high in comparison with the conventional cases, not when air permeability is improved, but instead when the CO₂ concentration is increased during the sprouting step of the fungal bed cultivation method of a hon-shimeji mushroom. Additionally, it has also been found that when the CO₂ concentration is increased during the growing step of fruit bodies, yield of the fruit bodies is increased. Further, voids of the petiole part, which have been difficult to control in the past, are decreased or even disappear, even when grown into a large fruit body characteristic to a hon-shimeji mushroom. Further, the opening of its pileus can be suppressed, thereby achieving a method suitable for cultivating large fruit bodies with high quality.

Thus, embodiments of the present invention relate to a fungal bed cultivation method of a hon-shimeji mushroom, comprising at least one of carrying out a part of or entire sprouting step under an environmental condition of high CO₂ concentration and carrying out a part of or entire a fruit body growing step under an environmental condition of high CO₂ concentration.

Thus, an embodiment of the present invention involves a fungal bed cultivation method of a hon-shimeji mushroom, wherein the high CO₂ concentration during the sprouting step is 2,500 ppm or more, preferably 5,000 ppm or more, more preferably within the range of 5,000 to 35,000 ppm, further even more preferably within the range of from 10,000 to 20,000 ppm. An embodiment of the present invention involves a fungal bed cultivation method of a hon-shimeji mushroom, wherein the high CO₂ concentration during the fruit body growing step is 5,000 ppm or more, preferably within the range of 5,000 to 35,000 ppm, more preferably within the range of from 10,000 to 20,000 ppm. Further the sprouting step of said fungal bed cultivation method of a hon-shimeji mushroom may be carried out under the above environmental conditions for at least one day, preferably for one to ten days, more preferably for three to six days. Further, the fruit body growing step may be carried out under the above environmental conditions for at least two days, preferably for two to five days. Additionally, only one of the sprouting or fruit body growing step may be carried out under said environmental conditions, or both the sprouting and the fruit body growing step may be carried out under said environmental conditions.

According to embodiments of the present invention, a fungal bed cultivation method of a hon-shimeji mushroom, in which a hon-shimeji mushroom is produced stably by a large scale commercial cultivation, is provided. By using the present invention, large fruit bodies of a hon-shimeji mushroom having an excellent shape can be stably obtained.

### DETAILED DESCRIPTION OF EXEMPLARY EMBODIMENTS

The following provides a detailed description of exemplary embodiments of the present invention.

As used in the present specification, the term “hon-shimeji mushroom” means a mushroom which is taxonomically classified into Lyophyllum shimeji.

The strain of the hon-shimeji mushroom to be used in the present invention is not particularly limited and can be any strain which is either a commercial strain or a strain obtained from a wild type fruit body by breeding using methods such as tissue separation, selection, crossing, cell fusion, genetic recombination or the like, which can be applied to an artificial fungal bed cultivation method. For example, Lyophyllum shimeji La 01-27 (FERM BP-10960), Lyophyllum shimeji La 01-20 (FERM BP-10959), Lyophyllum shimeji La 01-37 (FERM P-17456), Lyophyllum shimeji La 01-45 (FERM P-17457), Lyophyllum shimeji La 01-46 (FERM P-17458) and mutant strains thereof, which are suited for cultivation, can be exemplified.

There is no limitation to the above-mentioned strains and can be any strain that can be used in fungal bed cultivation.

The fungal bed cultivation method of a hon-shimeji mushroom according to an exemplary embodiment of the present invention is not particularly limited and can be any fungal bed cultivation method that can be carried out under an environmental condition of high CO₂ concentration, and thus, a bottle cultivation, a bag cultivation, a box cultivation and the like could be employed.

The following describes the fungal bed cultivation method of a hon-shimeji mushroom of an exemplary embodiment of the present invention by bottle cultivation as an example, wherein the method comprises the steps of preparation of a culture medium, filling in a bottle, sterilization, inoculation, culturing, (as occasion demands, fungal scraping: a step to accelerate the formation of a primordia of a fruit body by scraping the seed culture part of the culture medium and the surface of the culture medium), formation of primordia, sprouting (formation and growth of a budlet), isolation and transplantation of a cutting (budlet) as occasion demands, growth from a budlet into a mature fruit body, harvest of a mature fruit body, and the like. Next, these exemplary steps are illustratively described, though exemplary embodiments of the present invention are not limited to the contents of this illustrative description.

The “preparation of a culture medium” means a step of weighing and mixing respective base materials to be used in the fungal bed cultivation and adding water to adjust the moisture to a moisture-wet condition suited for the fungal bed cultivation of a hon-shimeji mushroom. The culture medium for the cultivation on fungal bed of a hon-shimeji mushroom (also called the medium) has no limitation and may be any material which can be used in the cultivation, but a combination of corns and sawdust is suitable. Regarding the sawdust, any sawdust derived from a broad-leaved tree or a needle-leaf tree can be used, and preferably, sawdust derived from a needle-leaf tree, such as sawdust derived from a cedar (Sugioga), can be exemplified. The term corns as used in the present specification is not particularly limited and can be any type of corn that contains corn seeds, and for example, fresh seeds of corn and dried, pulverized, rolled or heated and rolled product of the seeds can be exemplified.

A mixing ratio of the corns and sawdust derived from a needle-leaf tree is described in the case of heat-rolled corn and sawdust derived from a cedar (Sugioga) as an example. The mixing ratio of the corns and sawdust derived from a needle-leaf tree may be any ratio so long as it is a ratio at which a hon-shimeji mushroom can be cultivated. From the viewpoint of realizing a high yield, a lower limit of the heat-rolled corn content is 40% or more, preferably 50% or more, more preferably 60% or more, by dry weight ratio of the culture medium for cultivation on fungal bed. When the lower limit of the heat-rolled corn content becomes less than 40%, yield of the obtained hon-shimeji mushroom is considerably reduced, which is not desirable. Additionally, since the heat-rolled corn's absorption property of water is low, when its content in the culture medium for cultivation on fungal bed becomes too high, the moisture retaining ability of the culture medium for cultivation on fungal bed is lowered and water stays at the bottom part of a culture bottle, which can sometimes result in poor mycelium propagation. Thus, an upper limit of the heat-rolled corn content is 80% or less, preferably 75% or less, more preferably 70% or less, by dry weight ratio of the culture medium for cultivation on fungal bed.

In addition, the moisture content of the culture medium for cultivation on fungal bed is described also in the case of heat-rolled corn and Sugioga (cedar). It is desirable that the moisture content of the culture medium for cultivation on fungal bed is adjusted, in accordance with common sense of those skilled in the art, to a level that water does not stay at the bottom part of a culture bottle. The moisture content is not particularly limited, but is, for example, 68% by weight or less, preferably 66% by weight or less. However, when the moisture content exceeds 64% by weight, air gaps in the medium are reduced, thus sometimes causing poor mycelium propagation, so that the yield and quality of the fruit bodies obtained are reduced in some cases. Accordingly, it is more desirable to adjust the moisture content to 64% by weight or less. In this connection, poor mycelium propagation and malformation or poor generation of a fruit body occur when the moisture content is too low, due to the influence of drying of the medium and the like. That is, the moisture content is adjusted to be preferably 50% by weight or more, more preferably 55% by weight or more. The moisture content can optionally be set by considering conditions of the moisture-adjusted medium.

The “filling in a bottle” is a step of filling the culture medium for cultivation on fungal bed in a bottle. Illustratively, this is a step in which a 400 to 2,300 ml capacity heat resistant wide-mouthed culture bottle generally used for bottle cultivation is filled under pressure with a prepared culture medium for cultivation on fungal bed. For example, in the case of a 1,100 ml capacity bottle, 550 to 900 g, preferably 600 to 850 g, more preferably 650 to 750 g, of the prepared culture medium for cultivation on fungal bed is added. Further, one or more holes (also called hollows) having a bore diameter of approximately 1 to 3 cm are drilled in the pressure-filled culture medium for cultivation on fungal bed, and the bottle is corked. The number of holes per one bottle can be optionally set in response to the size of the bottle mouth, but culturing of a hon-shimeji mushroom can be carried out more suitably, for example by drilling a hole having a bore diameter of 1.5 to 2.0 cm in the central part of a surface region of the pressure-filled culture medium for cultivation on fungal bed, and four holes of 1 cm in bore diameter around the central hole.

The “sterilization” may be a step of carrying out extinction of all microorganisms in the medium. This is generally carried out at 98 to 100° C. for 4 to 12 hours in the case of ordinal pressure sterilization by steam, or at 101 to 125° C., preferably 118° C., for 30 to 90 minutes in the case of high pressure sterilization. The medium produced in this manner is called a medium for cultivation in some cases in the present invention.

The “inoculation” is a step of planting a seed culture in the medium after it has been cooled following sterilization. In general, a liquid seed culture prepared by culturing the mycelium of a hon-shimeji mushroom in a liquid medium is used as the seed culture. Though the medium used for the production of a liquid seed culture is not particularly limited, PGY liquid medium which contains glucose, peptone and yeast extract as the main components and is supplemented with KH₂PO₄, MgSO₄/7H₂O and the like or ½ PGY liquid medium, GY medium which contains glucose and yeast extract as the main components, ½ GY medium and the like can be exemplified. A preparation obtained by inoculating the hon-shimeji mushroom mycelium into said liquid medium and culturing, for example, at 25° C. for ten to 15 days, can be used as the liquid seed culture. Culturing of the liquid seed culture can be carried out using a flask or a jar fermentor. When a liquid seed culture is cultured in order to carry out a large scale cultivation, a jar fermentor is suitable from the view point that the number of days can be shortened with further large volume. Though the seed culture content of the liquid seed culture to be used in the inoculation of seed culture onto the cultivation medium is not particularly limited, a dry seed culture content from 0.1 to 10 g/l, preferably from 1 to 7 g/l, particularly preferably from 2 to 5 g/l, is exemplified. Also, the inoculum volume of the seed culture, may be approximately 5 to 30 ml per one wide-mouthed bottle of 1,100 ml capacity, for example, can be exemplified. Additionally, a conventionally known solid seed culture can also be used. For example, a preparation obtained by effecting mycelium propagation by culturing the culture medium for cultivation on fungal bed inoculated with the liquid seed culture, obtained by the steps so far described, at 25° C. for 60 to 150 days, can be used as a solid seed culture. For example, about 15 g of this solid seed culture per one wide-mouthed bottle of 1,100 ml capacity may be aseptically inoculated.

The “culturing” is a step of culturing the medium inoculated with seed culture, which carries out elongation, extension throughout the culture medium and aging of the mycelia. In general, mycelia are extended throughout the inoculated culture medium for cultivation on fungal bed at a temperature of from 20 to 25° C. and at a humidity of from 50 to 80%, and further aged. In this connection, the aging can be omitted. The culturing step can be optionally set depending on the volume of the culture medium and is carried out generally for 80 to 120 days, preferably for about 100 days, in the case where a 1,100 ml capacity bottle is used. The culturing step may be divided into a pre-culturing step and post-culturing step, and the post-culturing step of vigorous elongation of mycelia may be managed at a slightly lower temperature. In that case, the pre-culturing step is completed by 75 to 85 days, and the post-culturing step by 25 to 35 days.

The “formation of primordia” is a step of forming primordia of a fruit body of a hon-shimeji mushroom. After completion of the culturing step, the culture mixture is transferred to a room under an environment of 19 to 22° C., preferably around 20° C., a humidity of 60 to 80% and an illuminance of 1,000 lux or less, and formation of primordia of a fruit body is carried out by removing the cap of the bottle. The step of forming primordia requires 10 to 20 days. In addition, the primordia of a fruit body may be formed on the surface of the culture medium (the surface region of the upper region of the cultivation medium) at the aforementioned post-culturing step, for example by carrying out light irradiation of 20 lux-hour or more of integration illuminance.

The “sprouting” is a step of forming a sprout (budlet: a condition in which a grayish white fungal pileus is formed on the tip of primordium differentiated from primordia of a fruit body) from primordia of a fruit body and accelerating growth of the sprout (budlet) as occasion demands. The sprouting step is carried out for five to 15 days at generally between 10 to 20° C., preferably around 15° C., at a humidity of 80% or more, preferably under a high humidification condition exceeding 100%, and under an illuminance of 1,000 lux. Since dew drops are apt to be generated by humidification during the sprouting step, the fungal bed surface may be covered with a perforated plastic sheet, corrugated sheet or the like, or the culturing may be carried out by reversing the culture bottle, in order to prevent wetting. In addition, in order to accelerate the growth of a budlet, the fungal bed surface may be covered with soil using an appropriate covering soil material as occasion demands.

The “cutting”, as described in the following, is an isolated budlet to be used in the operation for transplanting the budlet obtained by the sprouting step onto the fungal bed cultivation medium for the mature fruit body formation. Steps of isolation of a cutting and a step of transplantation of a cutting are carried out when the preparation of large fruit bodies and unification of the shape of fruit bodies are desired.

The “isolation of a cutting” means a step of isolating the fruit body grown by the sprouting step. Isolation of a cutting may be carried out by selecting a most suitable method in response to the cultivar. For example, a budlet which can be easily isolated may be collected from the fungal bed with a hand or pinsetter and when the budlet is difficult to isolate, a desired budlet may be isolated and collected using optional tools such as a scalpel, kitchen knife, spatula or the like.

The “transplantation of a cutting” is a step of transplanting the cutting obtained by the step of isolation of a cutting onto an optional position of the medium for growing fruit body.

The medium to which the cutting is transplanted may be the medium used in the isolation of a cutting (medium after the isolation of a cutting) or a medium produced separately from said medium in which the mycelia of the mushroom have extended throughout the culture medium, such as a medium during the culturing step or a medium during the sprouting step. Also, it is possible to reuse the media after acquisition of mature fruit bodies by transplanting cuttings onto these media. It is possible to use as the medium during the culture step any medium between just after extension of mycelia throughout the culture medium until after completion of maturation, but is a culture mixture that has passed the culturing step by preferably 70 days or more, more preferably from 80 to 120 days. Additional, it is possible to use as the medium during the sprouting step, any one of medium between just after the commencement of sprouting until after completion of sprouting. When primordia of a fruit body, budlet and the like were already formed on the medium to be used for transplantation, the budlet to be used as the cutting can be transplanted onto a desired position after first removing these primordia of a fruit body, budlet and the like. In this connection, it is possible to use the removed budlet as the cutting to be used in the transplantation.

The transplantation method is not particularly limited and can include any method by which the transplanted cutting grows and fuses with mycelia on the fungal bed. Also, it is possible to transplant the cutting onto an optional position on the medium face. For example, it is desirable to insert or fit them into holes formed on the fungal bed before the culturing step or before the sprouting step, such as inoculation holes, vent holes and the like. These may also be inserted into holes newly bored before the cutting step. Bore diameter of these holes may be any bore diameter capable of effecting insertion of the cutting and therefore is not particularly limited, and it may be a diameter of generally from 2 to 20 mm, preferably from 4 to 10 mm. When one cutting, such as the budlet is transplanted and grown into one hole on the culture medium, independent large size fruit body having excellent shape without becoming a plant shape can be produced. In this connection, several budlets may be transplanted into one hole. In that case, the bases of respective fruit bodies adhere and become a plant shape, but since the adhering parts are limited to only small parts of the bases of fruit bodies, they can be easily separated one by one, so that independent mature fruit bodies having large size and excellent shape can be obtained, similar to the case of the fruit body obtained by transplanting one budlet into one hole. In addition, it is possible to obtain mature fruit bodies of uniform size, by classifying sizes of fruit bodies to be used as cuttings and transplanting the cuttings having approximately the same size into the medium and managing their cultivation.

In connection with this, when a cutting such as a budlet is transplanted, for example inserted, into a hole, it is desirable to insert in a manner that the budlet stands upright and a part of the budlet contacts with the medium.

The “growth from a budlet into a mature fruit body” is a step which is carried out for five to 15 days under almost the same conditions of the sprouting step except that the illuminance is generally 2,000 lux or less (to be simply referred to as a growing step in this specification in some cases). Since influence of wetting by dew drops is hardly received in the growing of a budlet into a mature fruit body, it is desirable that covering with a perforated plastic sheet, corrugated sheet or the like is not applied.

In the growing step of a budlet into a mature fruit body, a plant shape (multiple growth) mature fruit body can be obtained stably at a central part of the bottle, by carrying out the growing step by removing sprouts other than the sprout (budlet) at the central part of the surface of the culture medium, specifically sprouts of the edge (bottle edge region) of the surface of culture medium, after the aforementioned sprouting step. In this connection, when sprouts other than the sprout at the central part of the surface of the culture medium are removed, these can be mechanically removed along the bottle edge region. By carrying out the growing step after these treatments, it can be grown into plant shaped mature fruit body efficiently.

In addition, a single-grown large size fruit body of a hon-shimeji mushroom having high commercial value can be obtained when a step, during which among the sprouts developed on the medium surface, several sprouts desired to be grown into mature fruit bodies are selected and other sprouts are removed, is added to the aforementioned sprouting step or to an early stage of the growing step of a budlet into a mature fruit body (until on the fifth day). In connection with this, in the step to select the sprouts, nipping of sprouts of bottle edge region may be mechanically carried out, and at that time, the sprouts formed on the central part of the surface of culture medium may also be nipped mechanically as occasion demands. By further nipping sprouts other than the fruit bodies (budlets) suited for their growth after these treatments and selecting and breeding the remaining budlets, large size hon-shimeji mushroom fruit bodies having excellent shape can be grown efficiently.

Exemplary embodiments of the present invention are achieved by carrying out a part or the entire portion of the above-mentioned sprouting step and/or growing step under an environmental condition of high CO₂ concentration. The environmental condition of high CO₂ concentration means an environmental condition under which the CO₂ concentration is 2,500 ppm or more, preferably 5,000 ppm or more, more preferably within a range of from 5,000 to 35,000 ppm, further even more preferably within a range of from 10,000 to 20,000 ppm. More specifically, the CO₂ concentration in the sprouting step is 2,500 ppm or more, preferably 5,000 ppm or more, further preferably within a range of from 5,000 to 35,000 ppm, and still further preferably within a range of from 10,000 to 20,000 ppm. The CO₂ concentration in the growing step is 5,000 ppm or more, preferably within a range of from 5,000 to 35,000 ppm, further preferably within a range of from 7,000 to 20,000 ppm and still further preferably within a range of from 7,000 to 8,000 ppm. In this connection, the aforementioned environmental condition of high CO₂ concentration does not mean a condition of a constant CO₂ concentration but includes a condition under which the CO₂ concentration is changed within the aforementioned ranges. The method for adjusting the CO₂ concentration at a high concentration is not particularly limited and may be any method which can keep the CO₂ concentration at a high concentration, and the CO₂ concentration may be adjusted by controlling the ventilation of the place (room) where the sprouting step and/or growing step is carried out or the CO₂ concentration of said place may be adjusted using a CO₂ source, such as CO₂ gas or dry ice, and ventilation. In the sprouting step, the CO₂ concentration may be adjusted using the cap of a culture bottle. For example, after the culturing step and before entering the sprouting step, a ventilating part of the culture bottle cap may be closed partly or entirely or it may be exchanged with a cap having low air permeability.

Regarding the period for setting an environmental condition of high CO₂ concentration, the sprouting step may be carried out under the above-mentioned environmental condition for at least one day of the sprouting step, preferably one to ten days, more preferably three to six days. The period of high CO₂ concentration may begin at the commencement of the sprouting step. After the sprouting step under an environmental condition of high CO₂ concentration, the sprouting step may be continued for one to three additional days under an environmental condition of the general CO₂ concentration (about 1,000 ppm or less). Regarding the period for setting an environmental condition of high CO₂ concentration in the growing step, it is at least two days of the growing step, preferably three to five days. The period of high CO₂ concentration may begin at the commencement of the growing step. After the growing step under an environmental condition of high CO₂ concentration, growth of mature fruit bodies is carried out by continuing the growing step of fruit bodies under the general CO₂ concentration (less than 5,000 ppm).

A mature fruit body can be obtained by the above steps, and all steps of the cultivation may be completed by carrying out their harvest. Though the present invention has been described by a bottle cultivation method, the present invention can be applied to any fungal bed cultivation method of a hon-shimeji mushroom and is not limited to the above-mentioned bottle cultivation.

According to the present specification, the high humidification condition exceeding 100% in humidity means a condition under which water floats as a mist as a result of carrying out humidification at higher than the saturated vapor quantity. In order to express such a high humidification condition numerically, a device of Saginomiya Seisakusho, Inc. (trade name: Humid Eye 100) is used in the measurement. Said device uses a method in which moisture in the air is lowered by heating and detected by a humidity sensor and then the portion lowered by heating is corrected. Accordingly, the numerical value is identical to the relative humidity at 100% or less, but when it exceeds 100%, it becomes a numerical value in which the water content contained in the air is converted into water vapor and expressed by its ratio to a saturated water vapor quantity. In this connection, regarding the method for carrying out humidification, it is convenient to use humidifiers such as an ultrasonic humidifier, a steam humidifier, a spray humidifier or the like.

A fungal bed cultivation method of a hon-shimeji mushroom, which improves the formation ratio of a sprout (budlet), is provided by exemplary embodiments of the present invention. Since the formation ratio of a budlet is markedly improved by the present invention, stable production of a hon-shimeji mushroom makes possible commercial cultivation. Also, since the formation ratio of a budlet is improved, stable production of a plant shaped (multiple growth) hon-shimeji mushroom becomes possible. In the case of producing large size hon-shimeji mushrooms by the combination of steps of isolation and transplantation of cuttings, it becomes possible to stably obtain excellent cuttings in a large amount. In addition, in the case of producing large size hon-shimeji mushrooms in combination with a sprout nipping step, a large number of sprouts are generated, making it possible to keep sprouts stably around the central part of the culture bottle, which is a suitable region for the formation of fruit bodies and it becomes markedly easy to grow and select excellent sprouts at the medium position suited for growing large size hon-shimeji mushrooms. Thus, stable cultivation of hon-shimeji mushroom fruit bodies with improved yield becomes possible. Additionally, since opening of pilei of mature fruit bodies is suppressed by the present invention, it becomes possible to produce a hon-shimeji mushroom having a shape of high commercial value.

The following illustrative examples are used to further describe exemplary embodiments the present invention, but the present invention is not limited to the scope of the following Examples.

### Example 1

The mycelia of Lyophyllum shimeji La 01-27 (FERM BP-10960) were inoculated into 100 ml of PGY liquid medium (composition: glucose 2.0% (w/v), peptone 0.2% (w/v), yeast extract 0.2% (w/v), KH₂PO₄ 0.05% (w/v), MgSO₄.7H₂O 0.05% (w/v)), and cultured at 25° C. for seven days with shaking (100 rpm). 2 ml of the culture mixture was cultured to 200 ml of the same medium, and cultured for seven days with shaking (100 rpm). Further, the entire volume of the culture mixture was inoculated into a 200 l capacity jar fermentor (manufactured by Komatsukawa Seisakusho) charged with 160 l of the same medium and agitation cultured for six days (agitation speed: 100 rpm, aeration: 25 liters/min), thereby preparing a liquid seed culture. On the other hand, rolled corn (manufactured by Iisaka Seibakusha) and needle-leaf tree sawdust (manufactured by Tomoe Bussan) were mixed at a dry weight ratio of 2:1 (rolled corn:needle-leaf tree sawdust) and thoroughly agitated and mixed by adding water thereto in a volume that the final water content of the medium was 62% by weight. The mixture was put into a polypropylene wide-mouthed bottle (1,100 ml) (800 g in total weight including the bottle and cap) and pressure-packed. A hole of 2.0 cm in bore diameter was bored at the center of the pressure-packed material surface, four hollows each having a bore diameter of 1 cm and a depth of about 10 cm was bored on a circumference of 4 cm in diameter centering at the center of the pressure-packed material surface and then the culture bottle was capped. The capped culture bottle was subjected to autoclaving at 118° C. for 30 minutes and spontaneously cooled to 20° C. to prepare a culture medium for cultivation on fungal bed (solid medium). About 12.5 ml of the above-mentioned liquid seed culture was inoculated onto this solid medium, the mycelia were cultured in a dark room under condition of 20° C. in temperature and 70 to 75% in humidity for 105 days (pre-culturing 80 days, post-culturing 25 days) and the step was completed after confirming the primordia formation.

Next, the culture was divided into a general method (control) group and a sprouting step of high CO₂ concentration plot, and sprouting was carried out using 12 bottles for each group. After removing the cap and reversing the bottle, sprouting of the control group was carried out for seven days in a sprouting room where the temperature was controlled at 16° C., and the humidification at 115 to 120% as expressed by Humid Eye 100 (manufactured by Saginomiya Seisakusho, Inc.) and the illuminance at 100 lux or less on the surface of culture medium (intermittent intervals at 30 minutes of light and shade). On the other hand, the high CO₂ concentration plot was set to a high CO₂ concentration state by carrying out the sprouting while the cultivation bottle was capped. The cap used in this test plot was prepared by boring a through hole of 6 mm in diameter in its central position for carrying out measurement of CO₂ concentration in the cultivation bottle and covering its upper side with a vinyl tape, and this cap replaced the general cap used after completion of the above-mentioned culturing step. In the high CO₂ concentration plot, the sprouting was carried out for five days in the same sprouting room as the control, after which time the cap was removed and the bottle was reversed and then the sprouting was further carried out for an additional two days. The CO₂ concentration in the sprouting room was carried out using a CO₂ meter manufactured by VAISALA (type: GMT 220 series) and the CO₂ concentration in the cultivation bottle of the high CO₂ concentration plot was measured by inserting a detector tube manufactured by GASTEC (model number: No. 2L) into the through hole. Regarding the measurement by the detector tube, CO₂ concentrations in two cultivation bottles were measured each time and the average was used as the measured value. The CO₂ concentration during each sprouting step was measured at a frequency of once a day. Results of the measurement of CO₂ concentrations are shown in Table 1.

TABLE 1

| | |
|---|---|
| | CO₂ |
| Sprouting | concentration (ppm) |

| days | Control | High CO₂ concentration plot |
|---|---|---|
| 0th day | 1,040 | 28,500 |
| 1st day | 900 | 11,000 |
| 2nd day | 850 | 10,050 |
| 3rd day | 750 | 12,500 |
| 4th day | 820 | 16,500 |
| 5th day | 840 | 19,000 |
| Average | 867 | 16,000 |

Next, the culture bottles of respective test plots were returned to the normal position and transferred into a growth room where the temperature was controlled at 15° C., and the humidification at 110 to 115% as the value expressed by Humid Eye 100 (manufactured by Saginomiya Seisakusho, Inc.), and sprouts were grown for four days under illumination of 100 lux or less (intermittent intervals at 30 minutes of light and shade). Thereafter, the number of sprouts (budlets) formed on the surface of culture medium of each culture bottle was counted. The results are shown in Table 2.

TABLE 2

The number of
sprouts (budlets)

| | | High CO₂ |
|---|---|---|
| Bottle No. | Control | concentration plot |
| 1 | 17 | 41 |
| 2 | 19 | 44 |
| 3 | 32 | 64 |
| 4 | 21 | 42 |
| 5 | 6 | 107 |
| 6 | 8 | 136 |
| 7 | 5 | 118 |
| 8 | 16 | 155 |
| 9 | 24 | 92 |
| 10 | 29 | 121 |
| 11 | 38 | 107 |
| 12 | 19 | 56 |
| Average | 20 | 90 |

As is evident from Table 2, the average number of sprouts was 20 in the control, while the average number of sprouts in the high CO₂ concentration plot was 90, which is 4.5 times larger than the control. In addition, sprouts of the high CO₂ concentration plot were even in size in comparison with the control.

### Example 2

Culture mixtures which completed the culturing step were obtained in the same manner as in Example 1.

Next, the mixtures were transferred into a sprouting room where the temperature was controlled at 16° C., and the humidification at 115 to 120% as the value expressed by Humid Eye 100 (manufactured by Saginomiya Seisakusho, Inc.), and sprouting was carried out for seven days under illumination of 50 lux or less (intermittent intervals at 30 minutes of light and shade). In that case, sprouting was completed by setting eight test plots (12 bottles for each test plot), by carrying out sprouting for 0, 1, 2, 3, 4, 5 or 6 days without removing the cap and further continuing sprouting for 7, 6, 5, 4, 3, 2 or 1 day after removing the cap and reversing the bottle. The CO₂ concentration during the sprouting period was measured by the same method discussed in Example 1. CO₂ concentration inside the cap shifted within a range of from 10,000 to 25,000 ppm, and the average CO₂ concentration in the room was 1,050 ppm. Thereafter, culture bottles of respective test plots were returned to the normal position and transferred into a growth room where the temperature was controlled at 15° C., and the humidification at 110 to 115% as the value expressed by Humid Eye 100 (manufactured by Saginomiya Seisakusho, Inc.), and sprouts were grown for two days under illumination of 100 lux or less (intermittent intervals at 30 minutes of light and shade). Thereafter, the number of sprouts (budlets) formed on the surface of culture medium of each culture bottle was counted and the average number of sprouts in each test plot was calculated. The results are shown in Table 3.

TABLE 3

| Test plot | Average number of sprouts |
|---|---|
| Cap 0 day, Inversion 7 days | 64 |
| Cap 1 day, Inversion 6 days | 87 |
| Cap 2 days, Inversion 5 days | 74 |
| Cap 3 days, Inversion 4 days | 128 |
| Cap 4 days, Inversion 3 days | 113 |
| Cap 5 days, Inversion 2 days | 119 |
| Cap 6 days, Inversion 1 day | 117 |

From the above results, it was found that the number of sprouts obtained increases when sprouting is carried out under an environment condition of a high CO₂ concentration in which CO₂ concentration exceeds 10,000 ppm for at least one day during the sprouting period.

### Example 3

Culture mixtures which completed the culturing step were obtained in the same manner as in Example 1.

Next, three test plots were set for sprouting. That is, as the control, after removing the cap and reversing the bottle, sprouting was carried out for seven days in a sprouting room where the temperature was controlled at 16° C., and the humidification at 115 to 120% as the value expressed by Humid Eye 100 (manufactured by Saginomiya Seisakusho, Inc.), and the illumination under 50 lux or less (intermittent intervals at 30 minutes of light and shade) on the surface of culture medium. As the remaining two test plots, a plot in which the culture bottle was capped (cap plot) and a plot in which a semicircle portion of the fitted region of cap and culture bottle was sealed with a vinyl tape (semi-sealed plot) were set and sprouting was carried out in the same sprouting room as the control.

The CO₂ concentration during the sprouting period was measured by the same method discussed in Example 1. The average CO₂ concentration inside the cap of the cap plot was 20,000 ppm. Also, average CO₂ concentration inside the cap of the semi-sealed plot was 25,000 ppm. In addition, the average CO₂ concentration in the room was 1,000 ppm. Thereafter, caps were removed and the bottles were returned to the normal position and transferred into a growth room where the temperature was controlled at 15° C., and the humidification at 110 to 115% as the value expressed by Humid Eye 100 (manufactured by Saginomiya Seisakusho, Inc.), and sprouts were grown for two days under illumination of 100 lux or less (intermittent intervals at 30 minutes of light and shade), the number of sprouts (budlets) formed on the surface of culture medium of each culture bottle was counted to calculate the average number of sprouts per 12 bottles in each test plot. As a result, while the average number of the control was 60, the average number of the cap plot was 120 and the average number of the semi-sealed plot was 115, so that it was revealed that the number of sprouts increases when sprouting is carried out under a high CO₂ concentration environment.

### Example 4

Culture mixtures which completed the culturing step were obtained in the same manner as in Example 1.

Next, after removing the cap and reversing the bottle, sprouting was carried out for seven days in a sprouting room where the temperature was controlled at 16° C., and the humidification at 115 to 120% as the value expressed by Humid Eye 100 (manufactured by Saginomiya Seisakusho, Inc.), and the illuminance at 50 lux or less (intermittent intervals at 30 minutes of light and shade) on the surface of culture medium. The average CO₂ concentration during the sprouting period was adjusted to 2,500 ppm, 5,000 ppm and 7,000 ppm by controlling ventilation of the room, and the average number of sprouts per 16 bottles of each test plot was calculated. As a result, the number was 45, 68 and 92, respectively, so that it was revealed that the number of sprouts increases when sprouting is carried out under a high CO₂ concentration environment.

### Example 5

Culture mixtures which completed the culturing step were obtained in the same manner as in Example 1.

Next, after removing cap of each culture mixture and reversing the bottle, sprouting was carried out for seven days under illumination of 100 lux or less (intermittent intervals at 30 minutes of light and shade) after the bottle were transferred in a sprouting room where the temperature was controlled at 15° C., and the humidification at 115 to 120% as the value expressed by Humid Eye 100 (manufactured by Saginomiya Seisakusho, Inc.). Thereafter, the bottle was returned to the normal position and transferred into a growth room where the temperature was controlled at 15° C., and the humidification at 95 to 105% as the value expressed by Humid Eye 100 (manufactured by Saginomiya Seisakusho), and budlets to be used for cuttings were obtained by allowing them to grow for two days under illumination of 50 to 100 lux or less.

Further, using tweezers, the budlets obtained above were transplanted as cuttings one by one into 4 holes, excluding the center on the surface of culture medium, of another solid medium had been prepared using the above discussed process up to the culturing step. One case (16 bottles) of the cuttings-transplanted solid medium were prepared, eight bottles were covered with similar caps used in the sprouting of the high CO₂ concentration plot of Example 1 (test plot), and the remaining eight bottles without capping (control plot), and budlets were grown in the above-mentioned growth room under the same conditions except that the humidification was set to 105 to 120% as the value expressed by Humid Eye 100 (manufactured by Saginomiya Seisakusho). In the test plot, caps were removed on the fourth day after commencement of the growth and fruit bodies were harvested on the tenth day, those of the control plot were harvested on the tenth day, and yield (g/bottle) and void content (%) of each fruit body were measured. In this connection, the CO₂ concentration of the growth room was measured using a CO₂ meter (type: RI-85) manufactured by Riken Keiki. The CO₂ concentration in the culture bottles of the test plot was measured in the same method as in Example 1. Also, measurement of the CO₂ concentration during the growing step was carried out at a frequency of once a day. As a result, the CO₂ concentration in the room during the test period was approximately less than 5,000 ppm and the CO₂ concentration in the culture bottles was about 20,000 ppm in average.

As a result, average yield per bottle increased from 81 g to 85 g in the test plot, and void content (ratio of a fruit body in which void was generated in the petiole part) decreased from 6% to 3%. In addition, when ratio of a fruit body having pileus opening (brim of pileus is not rolled) was examined, it was 3% in the test plot while it was 28% in the control plot. That is, opening of pileus was remarkably reduced in the test plot, so that it became possible to obtain fruit bodies having excellent shape.

According to the present invention, a fungal bed cultivation method, in which a hon-shimeji mushroom is produced stably by a large scale commercial cultivation, is provided. By using said method, stable cultivation of a hon-shimeji mushroom having high formation ratio of a sprout (budlet) becomes possible. In addition, since pileus opening of a mature fruit body is suppressed, it becomes possible to produce a hon-shimeji mushroom having a shape of high commercial value.

While the invention has been described in detail and with reference to specific embodiments thereof, it will be apparent to one skilled in the art that various changes and modifications can be made therein without departing from the scope thereof.

What is claimed is:

1. A fungal bed cultivation method of a hon-shimeji mushroom, comprising:
at least one of:
carrying out a part of or entire sprouting step under an environmental condition of high CO₂ concentration and
carrying out a part of or entire a fruit body growing step under an environmental condition of high CO₂ concentration.

2. The cultivation method according to claim 1, wherein the high CO₂ concentration during the sprouting step is 2,500 ppm or more.

3. The cultivation method according to claim 1, wherein the high CO₂ concentration during the fruit body growing step is 5,000 ppm or more.

4. The cultivation method according to claim 1, wherein at least one day of the sprouting step is carried out under the environmental condition of high CO₂ concentration.

5. The cultivation method according to claim 1, wherein at least two days of the fruit body growing step are carried out under the environmental condition of high CO₂ concentration.
